(19) United States
(12) Patent Application Publication
(10) Pub. No.: US 2014/0082678 A1
(43) Pub. Date: Mar. 20, 2014

(54) VIDEO SERVER AND METHOD FOR RESTARTING REBUILDING

(71) Applicant: KABUSHIKI KAISHA TOSHIBA, Tokyo (JP)

(72) Inventors: Hiroki Nagai, Hino-shi (JP); Toshio Suzuki, Kawasaki-shi (JP)

(73) Assignee: KABUSHIKI KAISHA TOSHIBA, Tokyo (JP)

(21) Appl. No.: 13/949,584

(22) Filed: Jul. 24, 2013

(30) Foreign Application Priority Data
Sep. 14, 2012 (JP) 2012-203532

(51) Int. Cl. H04N 21/2747

(52) U.S. Cl. CPC H04N 21/2747
USPC 725/92

(57) ABSTRACT

According to one embodiment, a video server includes an ingesting device, a storage controller, storage devices and a control processor. The control processor controls the ingesting device and the storage controller to store the video signal. When one of the storage devices is replaced, the storage controller restores redundant or divisional data and reconstructs data stored in the original storage devices. When the control processor receives a request for ingesting a video signal and sufficient resources for ingesting do not remain while the control processor causes the storage controller to reconstruct the data, the control processor causes the storage controller to suspend reconstruction, and controls the ingesting device and the storage controller to perform the ingesting.

### CROSS-REFERENCE TO RELATED APPLICATIONS

This application is based upon and claims the benefit of priority from Japanese Patent Application No. 2012-203532, filed Sep. 14, 2012, the entire contents of which are incorporated herein by reference.

### FIELD

Embodiments described herein relate generally to a video server and a method for restarting rebuilding.

### BACKGROUND

A video server which ingests and plays back video content for broadcast stations is highly public. In such a video server, a failure in playback video content becomes a major problem. Therefore, high playback quality is strongly required in this type of video server.

In order to guarantee high playback quality, a video server is equipped with Reed-Solomon coding/decoding functions. Thereby, even in the event of a failure in a video content to be stored, it is possible to salvage or restore the video content in which the failure has occurred. In the Reed-Solomon coding/decoding functions, however, a video content might not be able to be salvaged or restored when a failure occurs in a part of a storage system storing the video content. This problem can be addressed by equipping redundant video server system including two video servers, thereby improving reliability. In order to have two video servers in the system, however, a significant increase in facility cost is expected. This makes it difficult to introduce such a video server system into small-scale television stations, such as local stations and cable television stations.

To address this, a RAID function is installed in the video server. Thereby, even when a failure occurs in a part of the storage system, video content can be restored and reconstructed at a low cost.

For example, in a video server equipped with a RAID function with N+1 redundancy, even when one of a plurality of storage devices provided in the storage system fails, a video content can be restored on the basis of data stored in the remaining N storage devices. Further, in such a video server, when the failed storage device is replaced with a new storage device, a video content can be reconstructed (hereinafter referred to as rebuilt) by restoring data stored in the failed storage device in the new storage device on the basis of data stored in the N storage devices.

Since the number of processes that can be simultaneously performed by the video server is limited, however, execution of a rebuilding process may cause effects such as delay in an ingesting process and a playback process of the video server.

### BRIEF DESCRIPTION OF THE DRAWINGS

FIG. 1 illustrates a configuration of a video playout system having a video server according to the embodiment;

FIG. 2 is a block diagram illustrating a functional configuration of the video server shown in FIG. 1;

FIG. 3 is a block diagram illustrating a functional configuration of a main control processor shown in FIG. 2 and information stored in a memory;

FIG. 4 illustrates a construction management information table stored in a memory of the main controller shown in FIG. 2;

FIG. 5 illustrates a resource management information table stored in the memory of the main controller shown in FIG. 2;

FIG. 6 illustrates an ingesting process and a playback process performed by a first memorization processor shown in FIG. 2;

FIG. 7 illustrates a restoration process performed by the first memorization processor shown in FIG. 2;

FIG. 8 illustrates a rebuilding process performed by the first memorization processor shown in FIG. 2;

FIG. 9 is a flowchart illustrating a procedure of the main controller shown in FIG. 2;

FIG. 10 is a flowchart illustrating a procedure of the main controller shown in FIG. 2; and

FIGS. 11A and 11B are flowcharts illustrating a procedure of the main controller shown in FIG. 2.

### DETAILED DESCRIPTION

In general, according to one embodiment, a video server includes an ingesting device, a storage controller, storage devices and a control processor. The ingesting device encodes a received video signal into video stream data and ingests the video stream data. The storage controller divides the video stream data into a plurality of items of divisional data by redundant array of independent disks (RAID) control and generates redundant data for restoring the divisional data. The plurality of storage devices store the divisional data and the redundant data generated by the storage controller. The control processor controls the ingesting device and the storage controller to store the video signal in the plurality of storage devices when resources sufficient for storing the video signal in the plurality of storage devices remain in the ingesting device, the storage controller, and the plurality of storage devices. When one of the plurality of storage devices is replaced, the storage controller restores redundant data or divisional data stored in the storage device to be replaced on the basis of divisional data or divisional data and redundant data stored in storage devices other than the storage device to be replaced and reconstructs data stored in the original storage devices in a plurality of storage devices. When the control processor receives a request for ingesting a video signal and sufficient resources for ingesting the video signal of which ingesting is requested in the plurality of storage devices do not remain while the control processor causes the storage controller to reconstruct the data stored in the original storage devices, the control processor causes the storage controller to suspend reconstruction being executed, and controls the ingesting device and the storage controller to perform the requested ingesting.

### First Embodiment

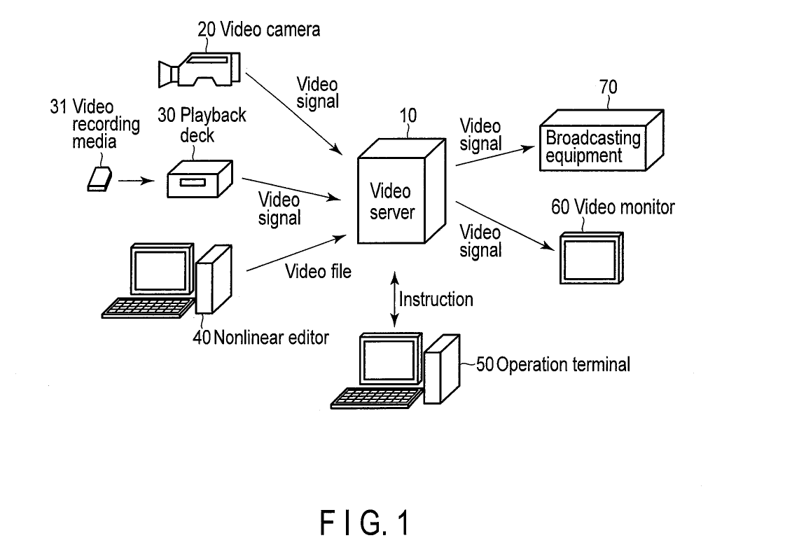

FIG. 1 is a schematic diagram illustrating an exemplary configuration of a video playout system having a video server 10 according to the embodiment. The video playout system shown in FIG. 1 has a video server 10, a video camera 20, a playback deck 30, a nonlinear editor 40, an operation terminal 50, a video monitor 60, and broadcasting equipment 70.

The video camera 20 outputs a video signal obtained by recording to the video server 10.

A video recording medium 31, in which video stream data or a video file are stored, is inserted into the playback deck 30. Video stream data is obtained by coding a video signal in a predetermined coding system set in advance, and a video file is obtained by converting video stream data in a file format such as Material eXchange Format (MXF). The playback deck 30 reads video stream data or a video file from a video recording media 31, converts the read video stream data or video file into a video signal, and outputs the converted video signal to the video server 10.

The nonlinear editor 40 reads the video file stored in the video server 10 according to a request from the user. The user edits the read video file using the nonlinear editor 40. The nonlinear editor 40 outputs the edited video file to the video server 10.

The operation terminal 50 accepts a command from the user and outputs the accepted command to the video server 10. Examples of such a command input from the user include commands requesting a process of ingesting a video signal, a process of requesting a video file, a process of playback a video signal, a process of outputting a video file, and a rebuilding process. A rebuilding process is a process of reconstructing, when one of a plurality of storage devices installed in a storage system in the video server 10 is replaced with a new storage device, video stream data or a video file stored in the original storage devices by restoring data stored in the storage device to be replaced in the new storage device on the basis of data stored in storage devices other than the storage device to be replaced.

The video monitor 60 receives a video signal obtained by playback video stream data or a video file stored in the video server 10. The video monitor 60 displays the video signal from the video server 10. The user determines whether it is necessary to perform an editing process, for example, by looking at display on the video monitor 60.

The broadcasting equipment 70 receives a video signal obtained by playback video stream data or a video file stored in the video server 10. The broadcasting equipment 70 broadcasts the video signal from the video server 10 to an area in which the broadcast service is provided.

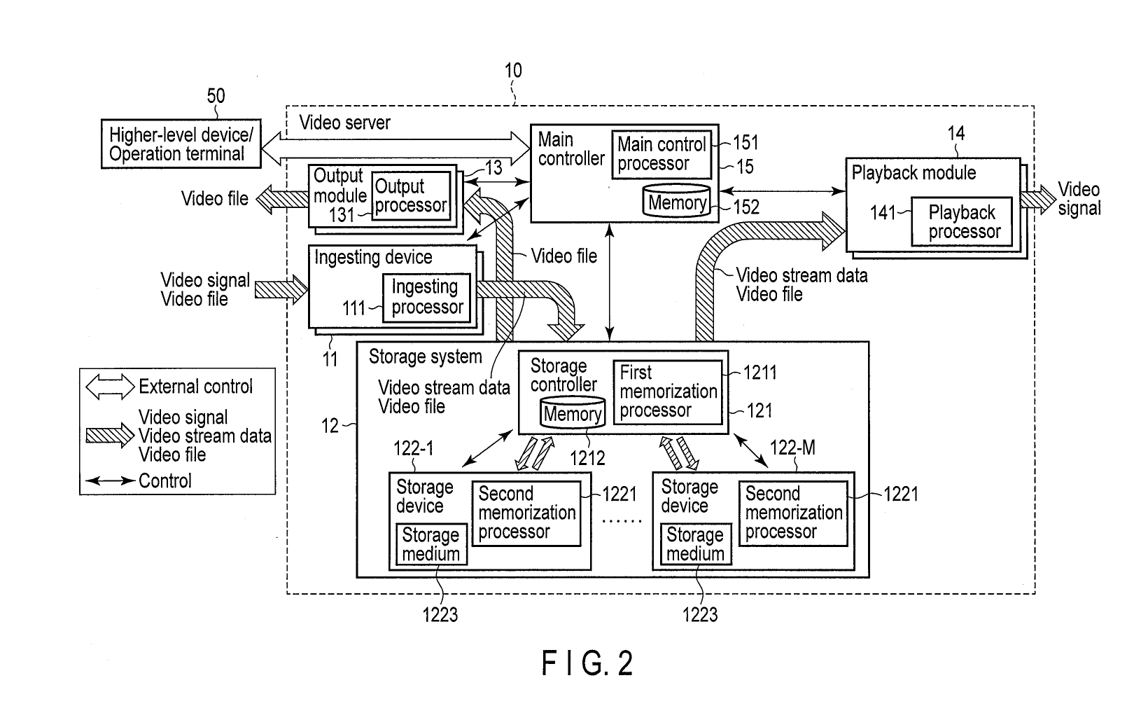

FIG. 2 is a block diagram illustrating a functional configuration of the video server 10 according to the embodiment. The video server 10 shown in FIG. 2 has an ingesting device 11, a storage system 12, an output module 13, a playback module 14, and a main controller 15. In the video server 10 shown in FIG. 2, a plurality of ingesting devices 11, a plurality of output modules 13, and a plurality of playback modules 14 are provided. The ingesting device 11, the storage system 12, the output module 13, the playback module 14, and the main controller 15 are connected via a bus or a network, for example.

The ingesting device 11 has a central processing unit (CPU), for example, and a read-only memory (ROM) and a random-access memory (RAM), for example, including a storage region for programs and data for the CPU to perform operations. The ingesting device 11 includes an ingesting processor 111, which causes the CPU to perform programs.

Upon receipt of a request for ingesting a video signal from the main controller 15, the ingesting processor 111 converts a video signal supplied from the outside to video stream data using a coding system set in advance. Examples of such a coding system set in advance include Moving Picture Experts Group-2 (MPEG-2) system. The ingesting processor 111 outputs the video stream data to the storage system 12.

Upon receipt of a request for ingesting a video file from the main controller 15, the ingesting processor 111 analyzes a video file supplied from outside and outputs the analyzed video file to the storage system 12.

The output module 13 has a CPU, for example, and a ROM and a RAM, for example, including a storage region for programs and data for the CPU to perform operations, and includes an output processor 131, which causes the CPU to perform programs.

Upon receipt of a request for outputting a video file from the main controller 15, the output processor 131 outputs a video file supplied from the storage system 12 to the outside.

The playback module 14 has a CPU, for example, and a ROM and a RAM, for example, including a storage region for programs and data for the CPU to perform operations, and includes a playback processor 141, which causes the CPU to perform programs.

Upon receipt of a playback request from the main controller 15, the playback processor 141 decodes video stream data supplied from the storage system 12 in accordance with the coding system of the ingesting device 11, and converts the decoded video stream data into a video signal. Upon receipt of a playback request, the playback processor 141 converts a video file supplied from the storage system 12 into a video signal. The playback processor 141 outputs the converted video signal to the outside.

The main controller 15 has a CPU, for example, and a ROM and a RAM, for example, including a storage region, for example, for programs and data for the CPU to perform operations. The main controller 15 includes a main control processor 151, which causes the CPU to perform programs, and a memory 152, and controls a process of ingesting a video signal, a process of ingesting a video file, a playback process, an output process, and a rebuilding process, for example, in the video server 10.

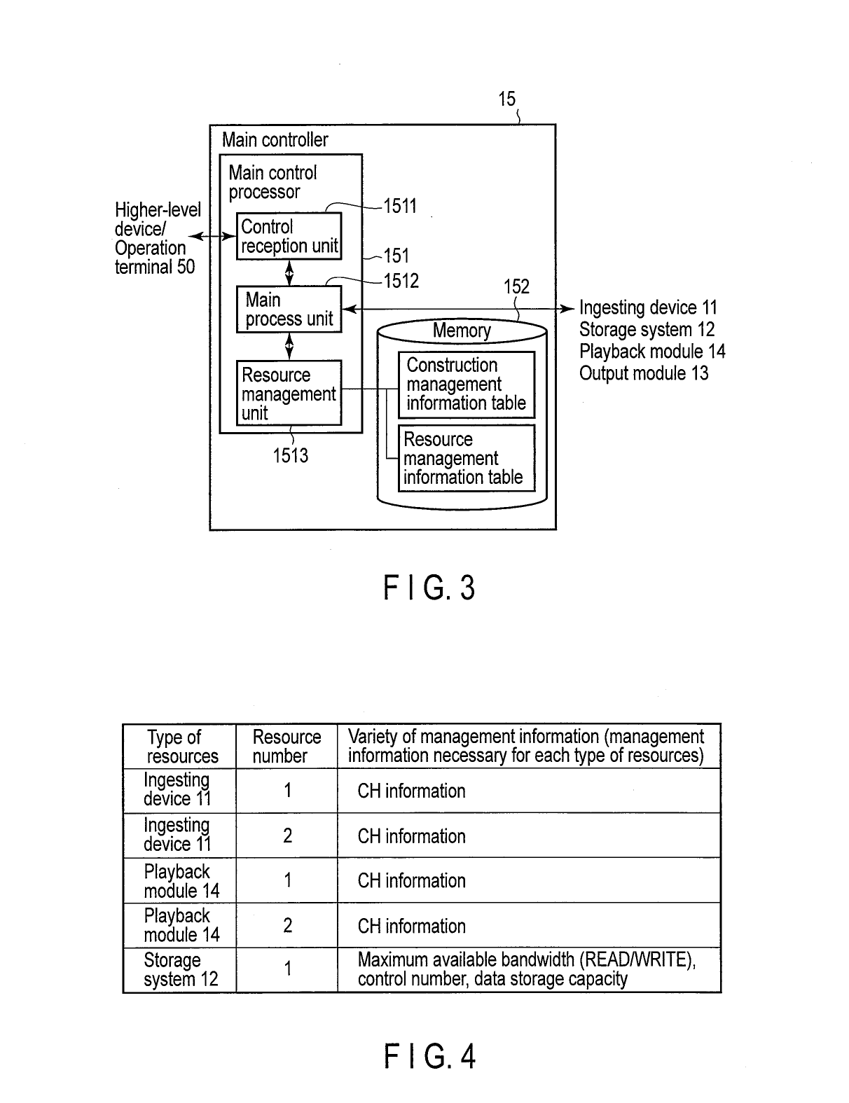

FIG. 3 is a block diagram illustrating a functional configuration of the main control processor 151 and information stored in the memory 152, according to the embodiment. The main control processor 151 shown in FIG. 3 has a control reception unit 1511, a main process unit 1512, and a resource management unit 1513. The memory 152 shown in FIG. 3 includes a construction management information table and a resource management information table.

FIG. 4 is an exemplary diagram illustrating the construction management information table stored in the memory 152. In FIG. 4, management information necessary for each type of resources is schematically shown, for the sake of simplicity. In the construction management information table shown in FIG. 4, information necessary for a process of ingesting a video signal, a process of ingesting a video file, a playback process, an output process, and a rebuilding process, for example, is managed for each constitutional device.

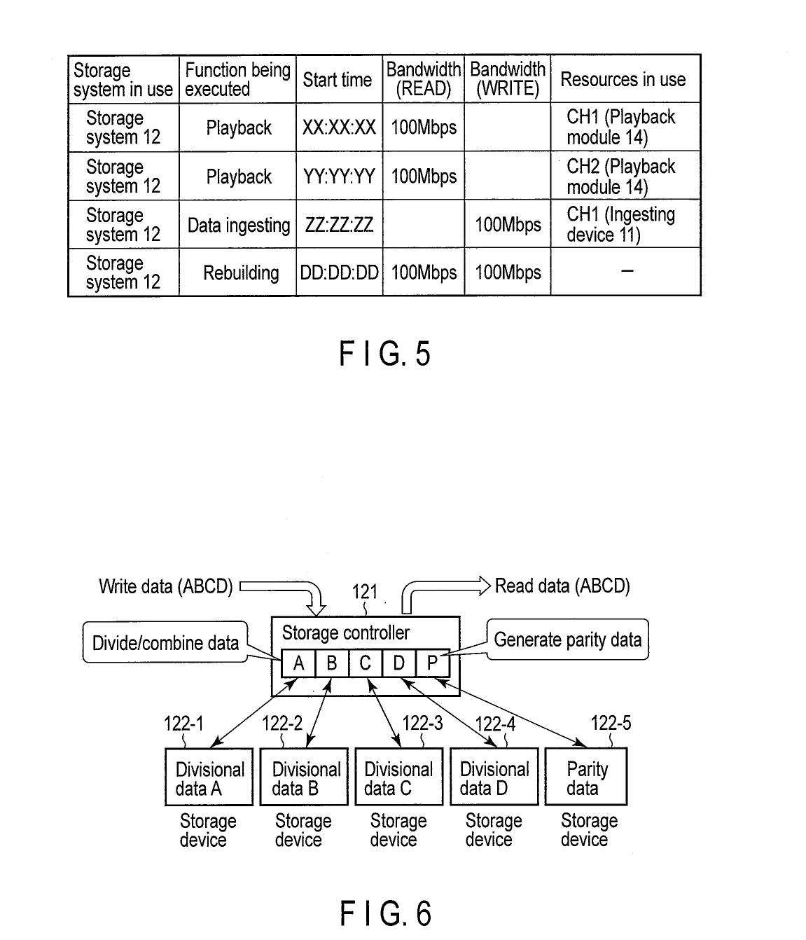

FIG. 5 is an exemplary diagram illustrating the resource management information table stored in the memory 152. The resource management information table shown in FIG. 5 represents a case where a process currently being executed, a start time of the process being executed, and a bandwidth in use, for example, of the storage system 12 are managed, by way of example. The main control processor 151 calculates a remaining bandwidth obtained by subtracting a bandwidth used in the process currently being executed from the maximum available bandwidth of the storage system 12. The main control processor 151 manages processes that can be simultaneously performed by referring to the calculated remaining bandwidth.

The control reception unit 1511 receives a command input from the operation terminal 50 or host device (not shown), and outputs the received command to the main process unit 1512.

Upon receipt of a response message from the main process unit 1512, the control reception unit 1511 outputs the received response message to the operation terminal 50 or host device.

Upon receipt of a command supplied from the control reception unit 1511, the main process unit 1512 determines what the processing request specified by the received command is.

When the processing request specified by the command is a request for ingesting a video signal, the main process unit 1512 requests the resource management unit 1513 for resources that are available when a process of ingesting a video signal is performed. When the processing request specified by the command is a request for ingesting a video file, the main process unit 1512 requests the resource management unit 1513 for resources that are available when an ingesting process of ingesting a video file is performed. When the processing request specified by the command is a playback request, the main process unit 1512 requests the resource management unit 1513 for resources that are available when a playback process is performed. When the processing request specified by the command is an output request, the main process unit 1512 requests the resource management unit 1513 for resources that are available when an output process is performed. When the processing request specified by the command is a rebuilding request, the main process unit 1512 requests the resource management unit 1513 for resources that are available when a rebuilding process is performed. Resources are sources which are necessary for the video server 10 to perform operations, and are determined on the basis of the speed at which data is written into the storage system 12, the speed at which data is read from the storage system 12, the processing ability of the storage system 12, the data transfer ability of a bus or a network, and the like.

Upon receipt of information on an ingesting device 11 and a storage system 12 that are available for a process of ingesting a video signal from the resource management unit 1513, the main process unit 1512 generates a response message indicating reception of control. The main process unit 1512 outputs the generated response message to the control reception unit 1511. The main process unit 1512 stores video stream data in the storage system 12 by outputting a request for ingesting a video signal to the ingesting device 11 and the storage system 12.

Upon receipt of information on an ingesting device 11 and a storage system 12 that are available for a process of ingesting a video file from the resource management unit 1513, the main process unit 1512 generates a response message indicating reception of control. The main process unit 1512 outputs the generated response message to the control reception unit 1511. The main process unit 1512 stores the video file in the storage system 12 by outputting a request for ingesting a video file to the ingesting device 11 and the storage system 12.

Upon receipt of information on a playback module 14 and a storage system 12 that are available for a playback process from the resource management unit 1513, the main process unit 1512 generates a response message indicating reception of control. The main process unit 1512 outputs the generated response message to the control reception unit 1511. The main process unit 1512 reads video stream data from the storage system 12 by outputting a playback request to the playback module 14 and the storage system 12, and causes the playback module 14 to play back the video stream data.

Upon receipt of information on an output module 16 and a storage system 12 that are available for an output process from the resource management unit 1513, the main process unit 1512 generates a response message indicating reception of control. The main process unit 1512 outputs the generated response message to the control reception unit 1511. The main process unit 1512 reads the video file from the storage system 12 by outputting an output request to the output module 13 and the storage system 12, and causes the output module 13 to output the video file.

Upon receipt of information on resources that are available for a rebuilding process from the resource management unit 1513, the main process unit 1512 generates a response message indicating reception of control. The main process unit 1512 outputs the generated response message to the control reception unit 1511. The main process unit 1512 reconstructs content data or a content file stored in the storage system 12 by outputting a rebuilding request to the storage system 12.

Upon receipt of information indicating that there are no resources for executing a rebuilding process on the storage system 12 from the resource management unit 1513, the main process unit 1512 outputs information indicating that a rebuilding process is in a waiting state to the operation terminal 50 or host device via the control reception unit 1511.

Upon receipt of information indicating that a process of ingesting or playback a video signal cannot be performed due to a rebuilding process being executed from the resource management unit 1513, the main process unit 1512 outputs a request for suspending the rebuilding process being executed to the storage system 12. The main process unit 1512 releases resources of the storage system 12 allocated to the rebuilding process. The main process unit 1512 notifies the resource management unit 1513 of the release of resources of the storage system 12.

Upon receipt of a completion notification indicating that an ingesting process or a playback process of the video signal has been completed, the main process unit 1512 requests the resource management unit 1513 for resources that are available for starting the rebuilding process in a waiting state. Upon completion of the process of ingesting or playback the video signal, the main process unit 1512 requests the resource management unit 1513 for resources that are available for restarting the rebuilding process which has been suspended.

Upon receipt of a resource request made in accordance with a request for ingesting a video signal or a video file from the main process unit 1512, the resource management unit 1513 acquires an available ingesting device from the ingesting devices 11 and available resources in the storage system 12 by referring to the construction management information table and the resource management information table stored in the memory 152. The resource management unit 1513 outputs information on an available ingesting device and available resources in the storage system 12 to the main process unit 1512.

Upon receipt of a resource request made in accordance with a playback request from the main process unit 1512, the resource management unit 1513 acquires an available playback module from the playback modules 14 and available resources in the storage system 12, by referring to the construction management information table and the resource management information table stored in the memory 152. The resource management unit 1513 outputs information on an available playback module and available resources in the storage system 12 to the main process unit 1512.

When the resource management unit 1513 receives a resource request made in accordance with a request for ingesting or playback a video signal from the main process unit 1512, but there are no resources that can be allocated to the ingesting request or playback request due to a rebuilding process being executed, the resource management unit 1513 outputs information indicating that the ingesting request or playback request cannot be performed due to the rebuilding process being executed to the main process unit 1512. Upon receipt of a notification indicating that the resources allocated to the rebuilding process have been released from the main process unit 1512, the resource management unit 1513 updates the resource management information table. Upon receipt of a resource request made in accordance with a request for ingesting a video signal, the resource management unit 1513 acquires an available ingesting device of the ingesting devices 11 and available resources in the storage system 12, by referring to the construction management information table and the updated resource management information table. The resource management unit 1513 outputs information on the available ingesting device and the available resources in the storage system 12 to the main process unit 1512. Upon receipt of a resource request made in accordance with a playback request, the resource management unit 1513 acquires an available playback module from the playback modules 14 and available resources in the storage system 12 by referring to the construction management information table and the updated resource management information table. The resource management unit 1513 outputs information on the available playback module and the available resources in the storage system 12 to the main process unit 1512.

Upon receipt of a resource request made in accordance with an output request from the main process unit 1512, the resource management unit 1513 acquires an available ingesting device of the output module 16 and available resources in the storage system 12 by referring to the construction management information table and the resource management information table stored in the memory 152. The resource management unit 1513 outputs information on the available output module and the available resources in the storage system 12 to the main process unit 1512.

Upon receipt of a resource request made in accordance with a rebuilding request from the main process unit 1512, the resource management unit 1513 acquires resources for performing a rebuilding process on the storage system 12 by referring to the construction management information table and the resource management information table stored in the memory 152. The resource management unit 1513 outputs information on the available resources in the storage system 12 to the main process unit 1512. When there are not sufficient resources for performing a rebuilding process in the storage system 12, the resource management unit 1513 outputs information indicating that there are not sufficient resources for performing a rebuilding process on the storage system 12.

The storage system 12 has a storage controller 121 and storage devices 122-1 to 122-M.

The storage controller 121 has a CPU, for example, and a ROM and a RAM, for example, including a storage region for programs and data for the CPU to perform operations. The storage controller 121 includes a first memorization processor 1211, which causes the CPU to perform programs, and a memory 1212.

Upon receipt of a request for ingesting a video signal or a video file from the main controller 15, the first memorization processor 1211 causes the storage devices 122-1 to 122-M to store video stream data or a video file output from the ingesting device 11 using a redundancy system called redundant array of independent disks (RAID). Upon completion of the process of ingesting the video signal or video file, the first memorization processor 1211 outputs a completion notification to the main controller 15.

Upon receipt of a playback request from the main controller 15, the first memorization processor 1211 reads video stream data or video file from the storage devices 122-1 to 122-M using the RAID system. The first memorization processor 1211 outputs the read video stream data or video file to the playback module 14. Upon completion of the playback process, the first memorization processor 1211 outputs a completion notification to the main controller 15.

FIG. 6 illustrates a process in which the first memorization processor 1211 stores the video stream data supplied from the ingesting device 11 using the RAID system, and outputs the video stream data read from the storage devices 122-1 to 122-5 to the playback module 14. A description will be made based on the premise that the storage system 12 shown in FIG. 6 includes the storage devices 122-1 to 122-5.

Upon receipt of video stream data “ABCD” from the ingesting device 11, the first memorization processor 1211 divides the received video stream data into divisional data A, B, C and D. After generating the divisional data A, B, C and D, the first memorization processor 1211 generates parity data, which is redundant data for restoring the divisional data A, B, C and D. The first memorization processor 1211 outputs the divisional data A, B, C and D and the parity data to the storage devices 122-1 to 122-5, respectively. The first memorization processor 1211 repeats the above-described process on the video stream data supplied from the ingesting device 11 and outputs the 4 items of divisional data and 1 item of parity data in parallel to the storage devices 122-1 to 122-5.

After the divisional data A, B, C and D and the parity data are read from the storage devices 122-1 to 122-5, the first memorization processor 1211 constructs video stream data “ABCD” by combining the divisional data A, B, C and D. The first memorization processor 1211 outputs the combined video stream data “ABCD” to the playback module 14.

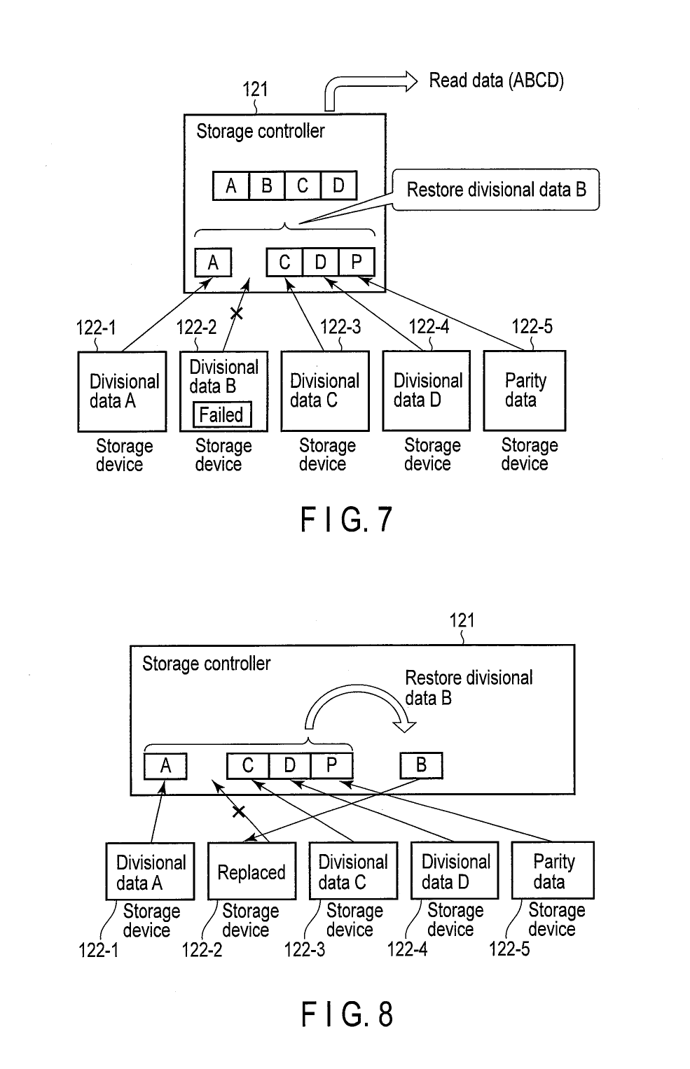

FIG. 7 illustrates a process of the first memorization processor 1211 when a part of a memory block of the storage device 122-2 fails and data cannot be read from the storage device 122-2.

In FIG. 7, since the storage device 122-2 fails, divisional data B cannot be read from the storage device 122-2. From the storage devices 122-1 and 122-3 to 122-5, on the other hand, divisional data A, C and D and parity data are read. The first memorization processor 1211 restores the divisional data B on the basis of the divisional data A, C and D and the parity data. The first memorization processor 1211 generates video stream data “ABCD” by combining the divisional data A, C and D and the restored divisional data B. The first memorization processor 1211 outputs the generated video stream data ABCD to the playback module 14.

Upon receipt of a rebuilding request from the main controller 15, the first memorization processor 1211 restores data stored in the storage device to be replaced and stores the restored data in a new storage device.

FIG. 8 illustrates a process in which, when the storage device 122-2 is replaced with a new storage device, the first memorization processor 1211 restores the original divisional data B in the new storage device 122-2 from divisional data A, C and D and parity data stored in the storage devices 122-1 and 122-3 to 122-5.

The first memorization processor 1211 notifies the storage devices 122-1 and 122-3 to 122-5, other than the storage devices that are targets for replacement, of a content ID, a leading frame number, and a frame length, which are notified of from the main controller 15, and reads the divisional data A, C and D and the parity data in parallel on the basis of the storage devices 122-1 and 122-3 to 122-5. The first memorization processor 1211 receives the divisional data A, C and D and the parity data read from the storage devices 122-1 and 122-3 to 122-5, and restores the divisional data B stored in the storage device to be replaced on the basis of the divisional data A, C and D and the parity data. The first memorization processor 1211 causes the new storage device 122-2, with which replacement is performed, to store the restored divisional data B.

Upon receipt of an output request from the main controller 15, the first memorization processor 1211 reads a video file from the storage devices 122-1 to 122-M using the RAID system. The first memorization processor 1211 outputs the read video file to the output module 13. Upon completion of the output process, the first memorization processor 1211 outputs a completion notification to the main controller 15.

Each of the storage devices 122-1 to 122-M has a CPU, for example, and a ROM and a RAM, for example, including a storage region for programs and data for the CPU to perform operations. Each of the storage devices 122-1 to 122-M includes a second memorization processor 1221, which causes the CPU to perform programs. Each of the storage devices 122-1 to 122-M further includes a storage medium 1222. A description has been made on the storage device 122-1, but operations of the storage devices 122-1 to 122-M are similar to that of the storage device 122-1.

The second memorization processor 1221 stores divisional data or parity data supplied from the storage controller 121 in the storage medium 1222.

Upon receipt of a reading request for playback from the storage controller 121, the second memorization processor 1221 reads divisional data or parity data from the storage medium 1222. The second memorization processor 1221 outputs the read divisional data or parity data to the storage controller 121.

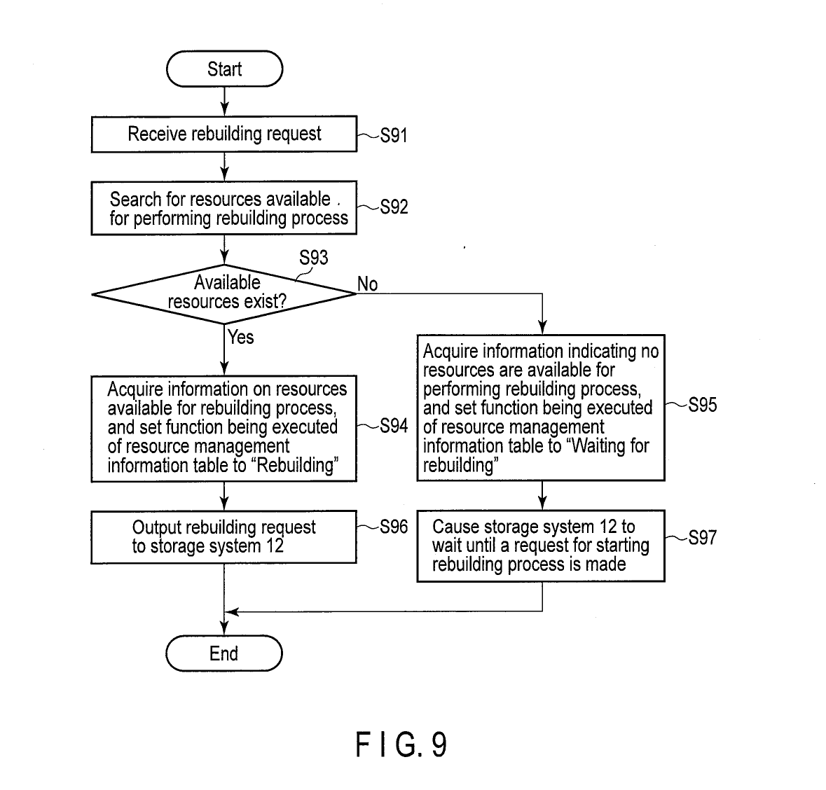

A rebuilding process of the video server 10 with the above-described configuration will now be described in detail. FIG. 9 is a flowchart illustrating a procedure of the main controller 15 when the video server 10 according to the embodiment performs a rebuilding process.

The main process unit 1512 receives a rebuilding request via the control reception unit 1511 (step S91). The main process unit 1512 requests the resource management unit 1513 for resources available for performing a rebuilding process on the storage system 12 (step S92).

Upon receipt of a resource request from the main process unit 1512, the resource management unit 1513 determines whether there are resources for performing a rebuilding process on the storage system 12, by referring to the construction management information table and the resource management information table stored in the memory 152 (step S93). When there are such resources (Yes in step S93), the resource management unit 1513 outputs information on the resources available for a rebuilding process to the main process unit 1512, and sets the function being executed on the storage system 12 of the resource management information table to “Rebuilding” (step S94). When there are no resources for performing a rebuilding process on the storage system 12 (No in step S93), the resource management unit 1513 outputs information indicating that there are no resources for performing a rebuilding process on the storage system 12 to the main process unit 1512, and sets the function being executed on the storage system 12 of the resource management information table to “Waiting for rebuilding” (Step S95).

Upon receipt of information on the resources that are available for a rebuilding process from the resource management unit 1513 in step S94, the main process unit 1512 outputs a rebuilding request to the storage system 12, thereby causing the storage system 12 to start a rebuilding process (step S96), and ends the process.

Upon receipt of information indicating that there are no resources available for a rebuilding process from the resource management unit 1513 in step S95, the main process unit 1512 causes the storage system 12 to wait until a request for starting a rebuilding process is made to the storage system 12 (step S97), and ends the process.

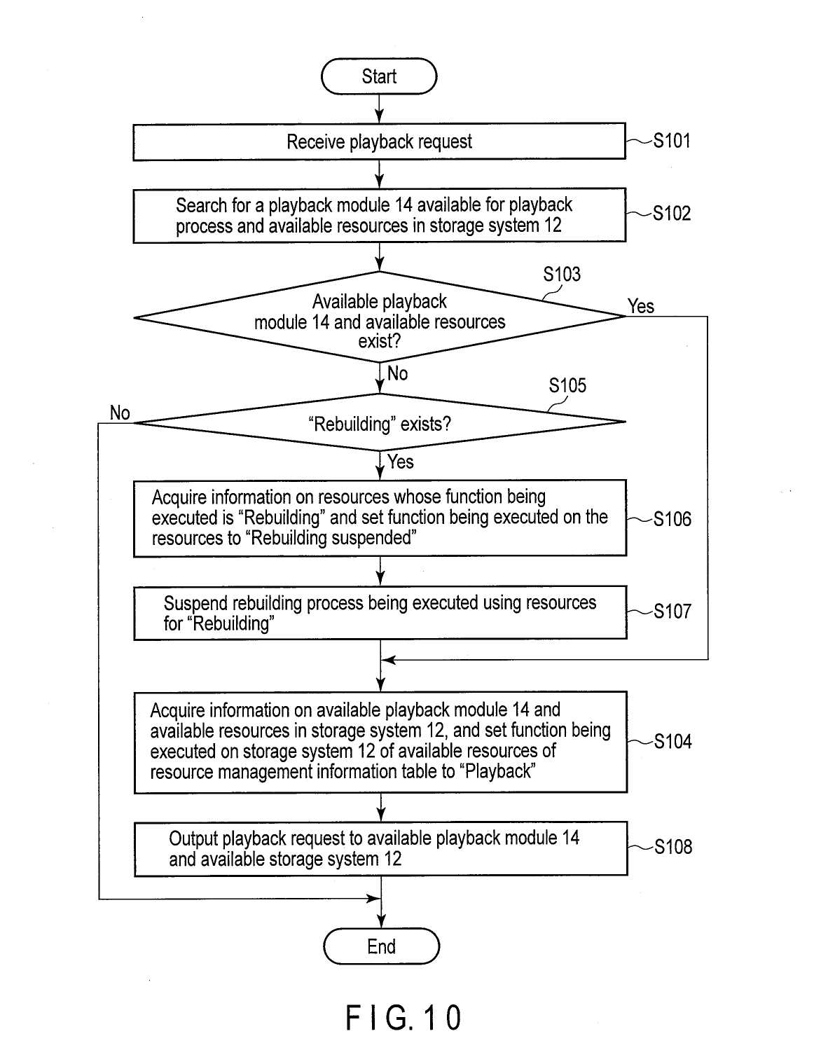

FIG. 10 is a flowchart illustrating a procedure of the main controller 15 when the video server 10 according to the embodiment performs a playback process. The main controller 15 performs a similar process when the video server 10 performs a process of ingesting a video signal.

The main process unit 1512 receives a playback request via the control reception unit 1511 (step S101). The main process unit 1512 requests the resource management unit 1513 for a playback module 14 available for a playback process and available resources in the storage system 12 (step S102).

Upon receipt of a resource request from the main process unit 1512, the resource management unit 1513 determines whether there are an available playback module in the playback modules 14 and available resources in the storage system 12, by referring to the construction management information table and the resource management information table stored in the memory 152 (step S103). When there are an available playback module and available resources in the storage system 12 (Yes in step S103), the resource management unit 1513 outputs information on the available playback module and the available resources in the storage system 12 to the main process unit 1512, and sets the function being executed on the storage system 12 of the available resources of the resource management information table to “Playback” (step S104). When there are no available playback modules and no resources in the storage system 12, i.e., when the resources are not sufficient (No in step S103), the resource management unit 1513 determines whether there are resources in the storage system 12 the function being executed of which is “Rebuilding” (Step S105).

When there are resources the function being executed of which is “Rebuilding” (Yes in step S105), the resource management unit 1513 notifies the main process unit 1512 of information on the resources the function being executed of which is “Rebuilding”, and sets the function being executed on the resources to “Rebuilding suspended” (step S106). When there are no resources the function being executed of which is “Rebuilding” (No in step S105), the resource management unit 1513 ends the process.

Upon receipt of information on the resources the function being executed of which is “Rebuilding” from the resource management unit 1513 in step S106, the main process unit 1512 suspends the rebuilding process being executed using the resources, thereby releasing resources allocated to the rebuilding process (step S107), and shifts the process to step S104.

Upon receipt of information on the available playback module and the available resources in the storage system 12 from the resource management unit 1513 in step S104, the main process unit 1512 outputs a playback request to the available playback module and the available storage system (step S108), and ends the process.

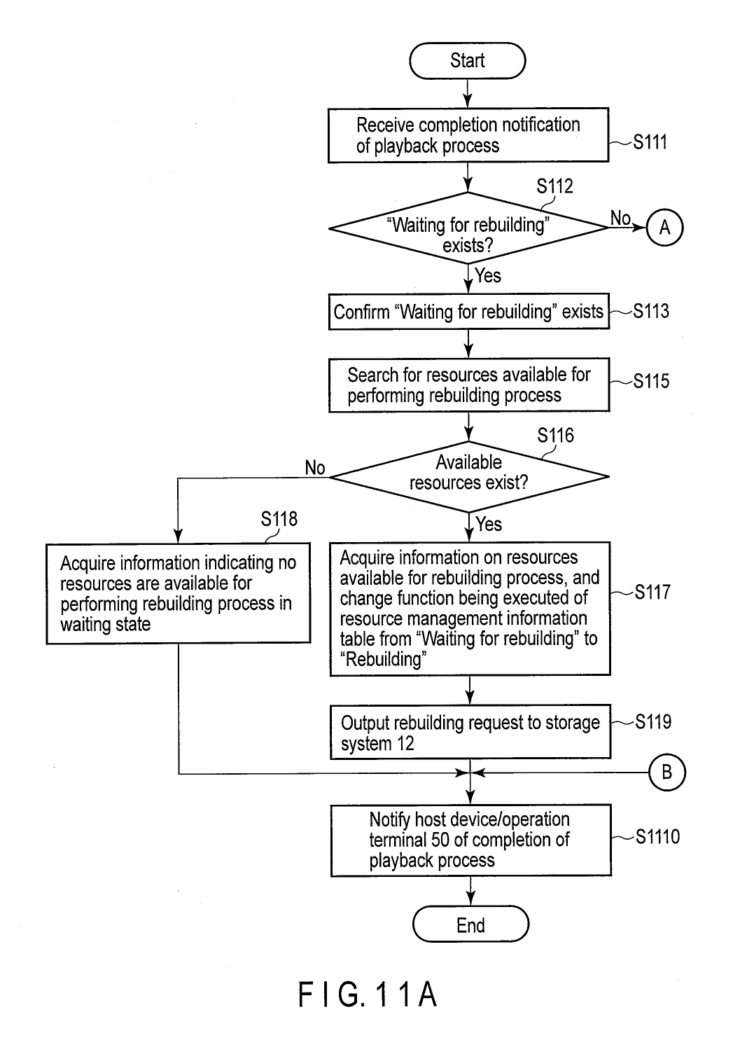

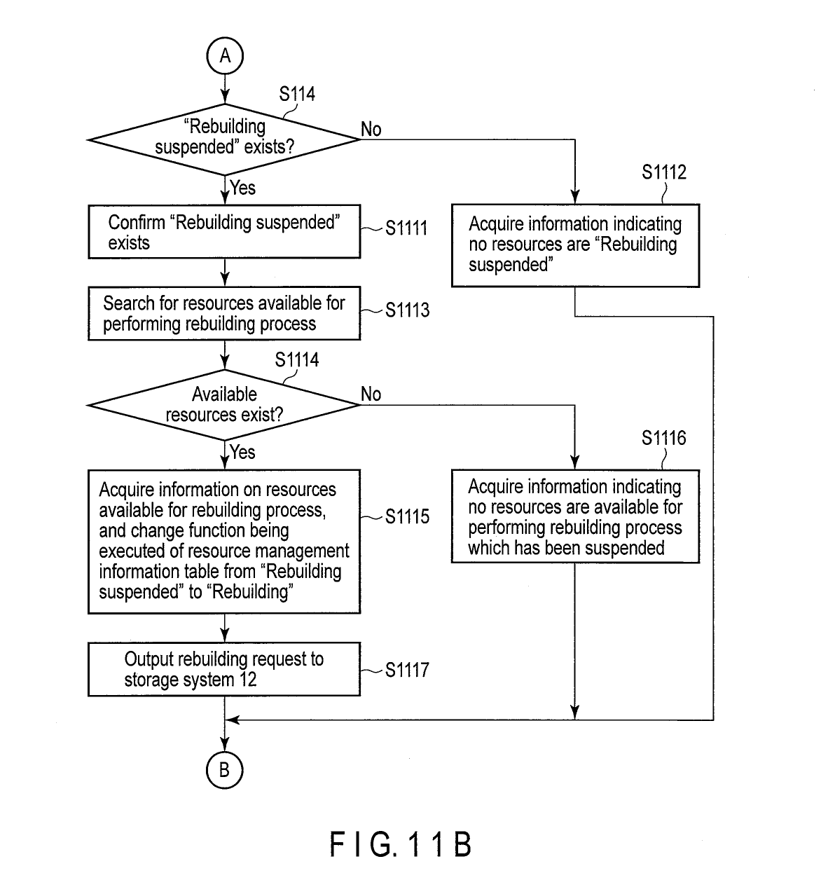

FIG. 11 is a flowchart illustrating a procedure of the main controller 15 when the video server 10 according to the embodiment starts a rebuilding process in a waiting state, and when the video server 10 according to the embodiment restarts a rebuilding process which has been suspended. In FIG. 11, a case will be described where a playback process has ended, by way of example, but a case where a process of ingesting a video signal has ended may also be taken as an example.

In FIG. 11A, the main process unit 1512 receives a notification of completion of a playback process (step S111). The main process unit 1512 outputs the received completion notification to the resource management unit 1513.

The resource management unit 1513 determines whether the state of the storage system 12 is “Waiting for rebuilding”, by referring to the resource management information table (step S112). When the state of the storage system 12 is “Waiting for rebuilding” (Yes in step S112), the resource management unit 1513 notifies the main process unit 1512 that the state of the storage system 12 is “Waiting for rebuilding” (step S113). When the state of the storage system 12 is not “Waiting for rebuilding” (No in step S112), the resource management unit 1513 shifts to “A”, and determines whether the state of the storage system 12 is “Rebuilding suspended” (step S114 in FIG. 11B).

Upon receipt of a notification indicating that the state of the storage system 12 is “Waiting for rebuilding” from the resource management unit 1513 in step S113, the main process unit 1512 requests the resource management unit 1513 for resources available for performing a rebuilding process waiting for rebuilding (step S115).

Upon receipt of a resource request from the main process unit 1512, the resource management unit 1513 determines whether there are resources for performing a rebuilding process in a waiting state, by referring to the construction management information table and the resource management information table stored in the memory 152 (step S116). When there are such resources (Yes in step S116), the resource management unit 1513 outputs information on the resources available for a rebuilding process in a waiting state to the main process unit 1512, and updates the function being executed of the resource management information table from “Waiting for rebuilding” to “Rebuilding” (step S117). When there are no resources for performing a rebuilding process in a waiting state (No in step S116), the resource management unit 1513 outputs information indicating that there are no resources for performing a rebuilding process in a waiting state to the main process unit 1512 (step S118).

Upon receipt of information on the resources available for a rebuilding process from the resource management unit 1513 in step S117, the main process unit 1512 causes the storage system 12 to start a rebuilding process by outputting a rebuilding request to the storage system 12, in which rebuilding is in a waiting state (step S119).

After that, the main process unit 1512 notifies the host device/operation terminal 50 that the playback process has ended (step S1110), and ends the process.

When the state of the storage system 12 is “Rebuilding suspended” in step S114 shown in FIG. 11B (Yes in step S114), the resource management unit 1513 notifies the main process unit 1512 that the state of the storage system 12 is “Rebuilding suspended” (step S1111). When the state of the storage system 12 is not “Rebuilding suspended” (No in step S114), the resource management unit 1513 notifies the main process unit 1512 that the state of the storage system 12 is not “Rebuilding suspended” (step S1112), and shifts the process from “B” to step S1110 shown in FIG. 11A.

Upon receipt of a notification indicating that the state of the storage system 12 is “Rebuilding suspended” from the resource management unit 1513 in step S1111, the main process unit 1512 requests the resource management unit 1513 for resources available for performing a rebuilding process which has been suspended (step S1113).

Upon receipt of a resource request from the main process unit 1512, the resource management unit 1513 determines whether there are resources for performing a rebuilding process which has been suspended, by referring to the construction management information table and the resource management information table stored in the memory 152 (step S1114). When there are such resources (Yes in step S1114), the resource management unit 1513 outputs information on the resources available for the rebuilding process which has been suspended to the main process unit 1512, and updates the function being executed of the resource management information table from “Rebuilding suspended” to “Rebuilding” (step S1115). When there are no resources for performing a rebuilding process which has been suspended (No in step S1114), the resource management unit 1513 outputs information indicating that there are no resources for performing a rebuilding process which has been suspended to the main process unit 1512 (step S1116), and shifts the process from “B” to step S1110 shown in FIG. 11A.

Upon receipt of information on the resources available for a rebuilding process from the resource management unit 1513 in step S1115, the main process unit 1512 outputs a rebuilding request to the storage system 12, in which a rebuilding process has been suspended, so as to cause the storage system 12 to restart a rebuilding process (step S1117), and shifts the process from “B” to step S1110 shown in FIG. 11A.

As described above, according to the present embodiment, if there are not sufficient resources for performing a process required to be performed in real time upon receipt of a request for a process required to be performed in real time, e.g., a request for ingesting or playback a video signal during execution of a rebuilding process, the main controller 15 suspends the rebuilding process. That is, the main controller 15 performs a process required to be performed in real time, in preference to a rebuilding process. Thereby, even when a rebuilding process is performed using the RAID system, it is possible to avoid the occurrence of a channel by which a video signal cannot be played back upon receipt of a playback request, due to reduction in maximum number of channels for simultaneous playback. It is also possible to avoid the occurrence of a channel by which a video signal cannot be ingested upon receipt of a request for ingesting a video signal, due to reduction in maximum number of channels for simultaneous ingesting.

In the present embodiment, the main controller 15 restarts a rebuilding process which has been suspended at the point in time when resources become available, after the process required to be performed in real time has ended. After the process required to be performed in real time has ended, the main controller 15 starts a rebuilding process in a waiting state at the point in time when the resources become available. Thereby, even when another process required to be performed in real time is performed in parallel, a rebuilding process can be started or restarted if there are available resources.

Therefore, according to the video server of the present embodiment, it is possible to perform a rebuilding process using the RAID function without affecting processes particular to the video server.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video server comprising:
an ingesting device configured to encode a received video signal into video stream data and ingest the video stream data;
a storage controller configured to divide the video stream data into a plurality of items of divisional data by redundant array of independent disks (RAID) control and generate redundant data for restoring the divisional data;
a plurality of storage devices configured to store the divisional data and the redundant data generated by the storage controller; and
a control processor configured to control the ingesting device and the storage controller to store the video signal in the plurality of storage devices when resources sufficient for storing the video signal in the plurality of storage devices remain in the ingesting device, the storage controller, and the plurality of storage devices, wherein
when one of the plurality of storage devices is replaced, the storage controller restores redundant data or divisional data stored in the storage device to be replaced on the basis of divisional data or divisional data and redundant data stored in storage devices other than the storage device to be replaced and reconstructs data stored in the original storage devices in a plurality of storage devices, and
when the control processor receives a request for ingesting a video signal and sufficient resources for ingesting the video signal of which ingesting is requested in the plurality of storage devices do not remain while the control processor causes the storage controller to reconstruct the data stored in the original storage devices, the control processor causes the storage controller to suspend reconstruction being executed, and controls the ingesting device and the storage controller to perform the requested ingesting.

2. The video server according to claim 1, wherein, when sufficient resources for restarting the reconstruction process which has been suspended remain when ingesting of the video signal has ended, the control processor controls the storage controller to restart the reconstruction process which has been suspended.

3. The video server according to claim 1, wherein
the storage controller generates video stream data on the basis of the divisional data and redundant data stored in the plurality of storage devices,
the video server further comprises a playback module configured to decode the generated video stream data into a video signal and play back the video signal, and
the control processor plays back, when sufficient resources for playback the video signal remain in the playback module, the storage controller, and the plurality of storage devices, the video signal by controlling the storage controller and the playback module, and controls, when the storage controller receives a request for playback a video signal and sufficient resources for playback a video signal of which playback is requested do not remain while the control processor causes the storage controller to reconstruct the data stored in the original storage devices, the storage controller and the playback module, so as to cause the storage controller to suspend the reconstruction being executed and perform the requested playback.

4. The video server according to claim 3, wherein
the storage controller generates a video file on the basis of the divisional data and redundant data stored in the storage devices, and
the playback module converts the generated video file into a video signal and plays back the video signal.

5. The video server according to claim 4, wherein, when sufficient resources for restarting the reconstruction process which has been suspended remain when playback of the video signal has ended, the control processor restarts the reconstruction process which has been suspended by controlling the storage controller.

6. A video server comprising:
a plurality of storage devices configured to store a plurality of items of divisional data obtained by dividing video stream data by redundant array of independent disks (RAID) control and redundant data for restoring the divisional data;
a storage controller configured to generate video stream data on the basis of the divisional data and redundant data stored in the plurality of storage devices;
a playback module configured to decode the generated video stream data into a video signal and play back the video signal; and
a control processor configured to play back the video signal by controlling the playback module and the storage controller when sufficient resources for playback the video signal remain in the playback module, the storage controller, and the storage devices, wherein
when one of the storage devices is replaced, the storage controller restores redundant data or divisional data stored in the storage device to be replaced on the basis of divisional data or divisional data and redundant data stored in storage devices other than the storage device to be replaced, and reconstructs data stored in the original storage devices in new storage devices, and
the control processor controls the playback module and the storage controller so as to cause the storage controller to suspend reconstruction being executed and perform the requested playback when the control processor receives a request for playback a video signal and sufficient resources for playback the video signal of which the playback is requested do not remain while the control processor causes the storage controller to reconstruct the data stored in the original storage devices.

7. The video server according to claim 6, wherein
the storage controller generates a video file on the basis of the divisional data and redundant data stored in the plurality of storage devices, and
the playback module converts the generated video file into a video signal and plays back the video signal.

8. The video server according to claim 7, wherein, when sufficient resources for playback the reconstruction process which has been suspended remain when playback of the video signal has ended, the control processor restarts the reconstruction process which has been suspended by controlling the storage controller.

9. A method for restarting rebuilding used in a video server comprising: a plurality of storage devices configured to store a plurality of items of divisional data obtained by dividing video stream data by redundant array of independent disks (RAID) control and redundant data for restoring the divisional data; and a storage controller configured to reconstruct, when one of the storage devices is replaced with a new storage device, data stored in the original storage devices in new storage devices by restoring redundant data or divisional data stored in the storage device to be replaced on the basis of divisional data or divisional data and redundant data stored in storage devices other than the new storage device, the method comprising:
determining, when a process required to be performed in real time is requested during execution of the reconstruction, whether resources necessary for executing the process remain;
causing the storage controller to suspend the reconstruction being executed and perform the process when resources necessary for executing the process do not remain;
determining whether resources necessary for restarting the suspended reconstruction process remain after the process has ended; and
restarting the suspended reconstruction process when resources necessary for restarting the suspended reconstruction process remain.
